(19) United States
(12) Patent Application Publication
(10) Pub. No.: US 2007/0121456 A1
(43) Pub. Date: May 31, 2007

(54) DEFECT SIGNAL GENERATING CIRCUIT

(75) Inventors: Hidetoshi Kono, Yokohama-shi (JP); Hiroaki Fujimori, Yamato-shi (JP); Jun Wakasugi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/562,637

(22) Filed: Nov. 22, 2006

(30) Foreign Application Priority Data
Nov. 25, 2005 (JP) 2005-340345

(51) Int. Cl. G11B 20/18

(52) U.S. Cl. 369/53.15

(57) ABSTRACT

A defect signal generating circuit comprises a low pass filter circuit which receives an input signal whose signal level is changed from a reference level to a higher level or a lower level corresponding to a dark defect or a bright defect of a optical disk, and outputs a low pass filter signal having a time constant longer than the input signal; an operation circuit which operates a difference between a level of the input signal and a level of the low pass filter signal, and outputs a first operation value; a defect determination circuit which determines whether a defect is the dark defect or the bright defect on the basis of the sign of the first operation value; a defect detection determination circuit which compares the absolute value of the first operation value with the absolute value of a first reference value, and determines that a defect is detected when the absolute value of the first operation value is larger than the absolute value of the first reference value; and an output circuit which outputs a first defect signal indicating that the dark defect is detected, when it is determined by the defect detection determination circuit that the defect is detected, and when it is determined by the defect determination circuit that the defect is the dark defect, and which outputs a second defect signal indicating that the bright defect is detected, when it is determined by the defect detection determination circuit that the defect is detected, and when it is determined by the defect determination circuit that the defect is the bright defect.

### CROSS-REFERENCE TO RELATED APPLICATIONS

This application is based upon and claims the benefit of priority from the prior Japanese Patent Application No. 2005-340345, filed on Nov. 25, 2005, the entire contents of which are incorporated herein by reference.

### BACKGROUND OF THE INVENTION

1. Field of the Invention

The present invention relates to a defect signal generating circuit used for an optical disk reproducing device.

2. Background Art

Conventionally, a defect signal generating circuit which detects a fault of an optical disk as a defect is used in an optical disk reproducing device for reproducing, for example, a CD-DA (Compact Disc Digital Audio), CD-R (Compact Disk Recordable), CD-RW (Compact Disk ReWritable) and the like. The defect includes a dark defect due to a stain and a flaw of the disk, and a bright defect in a state where a mirror face can be seen due to production failure (a state without a dye film).

The above described conventional defect signal generating circuit is provided with, for example, a first peak hold circuit which receives an RF (Radio Frequency) signal whose signal level is changed corresponding to a defect read from an optical disk and outputs a first detection signal changing almost simultaneously with the RF signal, a second peak hold circuit which receives the RF signal and outputs a second detection signal with a long time constant, a level adjusting circuit which divides the second detection signal into 1/n, and a comparator circuit which compares the divided second detection signal with the first detection signal and outputs a defect signal (see, for example, Japanese Patent Laid-Open No. 2005-203006). That is, in this defect signal generating circuit, the comparator circuit detects a defect on the basis of the level relation between the first detection signal and the divided second detection signal as a reference value to output the defect signal.

In the case where the level of the RF signal is lowered corresponding only to the dark defect due to a stain and a flaw of the CD-DA and the CD-R disk, the level of the first detection signal becomes lower than the level of the divided second detection signal. This enables the comparator circuit to output a defect detection signal, resulting in no problem in serve performance.

On the other hand, in the case where the level of the RF signal is raised corresponding to the bright defect, the level of the first detection signal is raised, but the level relation between the first detection signal and the divided second detection signal is not changed. Thus, a defect signal is not outputted from the comparator circuit, resulting in a problem that the bright defect is not normally detected as the defect.

Further, since the gain of a reproducing device is set to be high, for example, at the time of reproducing the CD-RW, the level of the first detection signal may become lower than the level of the divided second detection signal due to the end of the detection of the bright defect. At this time, the comparator circuit outputs the defect signal of the dark defect, resulting in a problem that the servo performance of the optical disc device is deteriorated to make the reproduction difficult.

### SUMMARY OF THE INVENTION

According one aspect of the present invention, there is provided: a defect signal generating circuit comprising a low pass filter circuit which receives an input signal whose signal level is changed from a reference level to a higher level or a lower level corresponding to a dark defect or a bright defect of a optical disk, and outputs a low pass filter signal having a time constant longer than the input signal; an operation circuit which operates a difference between a level of the input signal and a level of the low pass filter signal, and outputs a first operation value; a defect determination circuit which determines whether a defect is the dark defect or the bright defect on the basis of the sign of the first operation value; a defect detection determination circuit which compares the absolute value of the first operation value with the absolute value of a first reference value, and determines that a defect is detected when the absolute value of the first operation value is larger than the absolute value of the first reference value; and an output circuit which outputs a first defect signal indicating that the dark defect is detected, when it is determined by the defect detection determination circuit that the defect is detected, and when it is determined by the defect determination circuit that the defect is the dark defect, and which outputs a second defect signal indicating that the bright defect is detected, when it is determined by the defect detection determination circuit that the defect is detected, and when it is determined by the defect determination circuit that the defect is the bright defect.

According one aspect of the present invention, there is provided: a servo circuit comprising a defect signal generating circuit which SBAD signal or RFDC signal is inputted to; a focus servo which a focus error (FE) signal is inputted to; a tracking servo which a tracking error (TE) signal is inputted to; a feed servo; a disk motor servo; a servo control circuit which is arranged to output a control signal to control the output of the focus servo and the tracking servo on the basis of the output signal of the defect signal generating circuit; and a servo output circuit which controls a motor and a PU by a driver, to perform the reproduction of the disk, on the basis of outputs of the focus servo, the tracking servo, the feed servo, and the disk motor servo; wherein the defect signal generating circuit comprises a low pass filter circuit which receives SBAD signal or RFDC signal, and outputs a low pass filter signal having a time constant longer than SBAD signal or RFDC signal; an operation circuit which operates a difference between a level of the input signal and a level of the low pass filter signal, and outputs a first operation value; a defect determination circuit which determines whether a defect is the dark defect or the bright defect on the basis of the sign of the first operation value; a defect detection determination circuit which compares the absolute value of the first operation value with the absolute value of a first reference value, and determines that a defect is detected when the absolute value of the first operation value is larger than the absolute value of the first reference value; and an output circuit which outputs a first defect signal indicating that the dark defect is detected, when it is determined by the defect detection determination circuit that the defect is detected, and when it is determined by the defect determination circuit that the defect is the dark defect, and which outputs a second defect signal indicating that the bright defect is detected, when it is determined by the defect detection determination circuit that the defect is detected, and when it is determined by the defect determination circuit that the defect is the bright defect.

### BRIEF DESCRIPTION OF THE DRAWINGS

FIG. 1 is a block diagram showing a main part configuration of a defect signal generating circuit according to a first embodiment of the present invention;

FIG. 2 is a flow chart showing an operation for outputting the defect signal, performed by the defect signal generating circuit according to a first embodiment of the present invention;

FIG. 3 is a flow chart showing an operation for releasing the defect detection, performed by the defect signal generating circuit according to the first embodiment of the present invention;

FIG. 4 is a figure showing timing waveforms when the defect detection of the dark defect is performed by the defect signal generating circuit according to the first embodiment of the present invention;

FIG. 5 is a figure showing timing waveforms when the defect detection of the bright defect is performed by the defect signal generating circuit according to the first embodiment of the present invention;

FIG. 6 is a block diagram showing an example of a main part configuration of an optical disc device provided with the defect signal generating circuit according to the first embodiment of the present invention.

### DETAILED DESCRIPTION

A defect signal generating circuit according to the present invention, which receives an input signal whose signal level is changed to a level higher or lower than a reference level corresponding to the dark defect or the bright defect of an optical disk, is capable of more accurately detecting the dark defect and the bright defect of the optical disk as a defect, and of outputting a defect signal to a servo system of an optical disk reproducing device.

In the following, a preferred embodiment according to the present invention will be described with reference to the accompanying drawings.

### FIRST EMBODIMENT

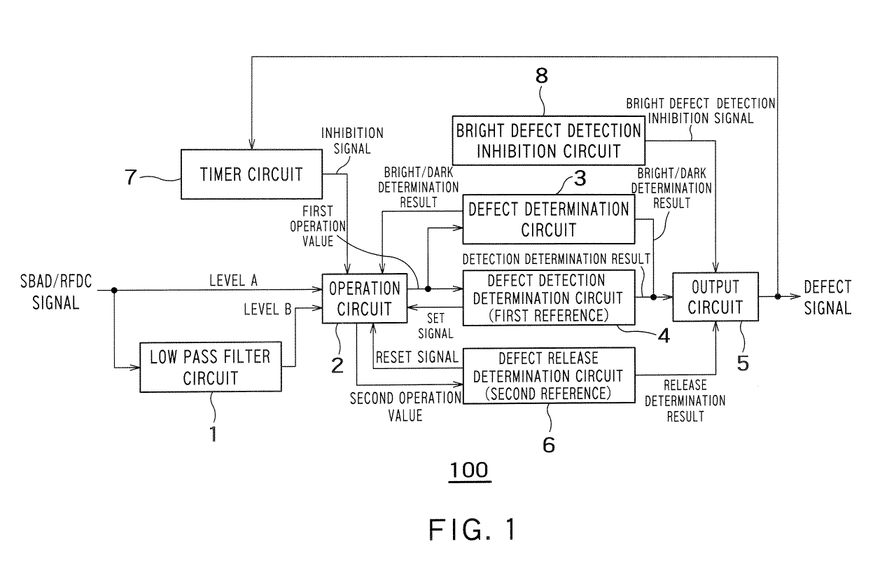

FIG. 1 is a block diagram showing a main part configuration of a defect signal generating circuit according to a first embodiment of the present invention.

As shown in FIG. 1, an input signal (for example, RFDC (Radio Frequency Direct Current) signal or a sub-beam addition signal (SBAD signal)) is inputted to a defect signal generating circuit 100, the signal level of which input signal is changed to a level higher or lower than a reference level corresponding to the dark defect and the bright defect of an optical disk, such as for example CD-DA, CD-R, and CD-RW.

It should be noted that the RFDC signal is a dc component signal of an RF signal, and is generated from an output of a main beam of the optical disk.

In addition, the sub-beams are control signals of a tracking servo, and are an E signal and an F signal of pickup outputs. Thus, a sum of the E signal and the F signal (E+F) is the sub-beam addition signal. For example, the level of the SBAD signal is lowered from the reference level corresponding to the dark defect of the optical disk, and returns to the reference level when the dark defect disappears. On the other hand, the level of the SBAD signal is raised from the reference level corresponding to the bright defect of the optical disk, and returns to the reference level when the bright defect disappears.

The defect signal generating circuit 100 is provided with a low pass filter circuit 1 which receives the above described input signal and outputs a low pass filter signal having a time constant longer than the input signal, an operation circuit 2 which operates the difference between the level of the input signal and the level of the low pass filter signal and outputs a first operation value, a defect determination circuit 3 which determines whether a defect is the dark defect or the bright defect on the basis of the sign of the first operation value, a defect detection determination circuit 4 which determines whether or not the defect is detected by comparing the absolute value of the first operation value with the absolute value of a reference value, and an output circuit 5 which outputs a defect signal to a servo system (not shown) on the basis of the determination results of the defect detection determination circuit 4 and the defect determination circuit 3.

The operation circuit 2 operates, for example, the difference (A−B) between the level A of the input signal (here SBAD signal) and the level B of the low pass filter signal, which difference is the first operation value.

For example, when the level A of the SBAD signal is lowered corresponding to the dark defect of the optical disk, the first operation value (A−B) becomes negative. On the other hand, when the level A of a SBAD signal is raised corresponding to the bright defect, the first operation value (A−B) becomes positive. And the operation circuit 2 outputs the first operation value (A−B) to the defect determination circuit 3.

The defect determination circuit 3 outputs the results of determination on the dark defect or the bright defect on the basis of the sign of the first operation value to the output circuit 5, and also to the operation circuit 2.

The defect detection determination circuit 4 compares, for example, the absolute value of the first operation value with the absolute value of a first reference value. When the absolute value of the first operation value is larger than that of the first reference value, the defect detection determination circuit 4 determines that a defect is detected. On the other hand, when the absolute value of the first operation value is not larger than the absolute value of the first reference value, the defect detection determination circuit 4 determines that the defect is not detected. Then, the defect detection determination circuit 4 outputs these detection determination results to the output circuit 5.

Further, when the defect is detected, the defect detection determination circuit 4 outputs a defect flag set signal indicating that the defect is currently detected, to the operation circuit 2.

When it is determined by the defect detection determination circuit 4 that the defect is detected, and when it is determined by the defect determination circuit 3 that the defect is the dark defect, the output circuit 5 outputs a first defect signal indicating that the dark defect is detected. On the other hand, when it is determined by the defect detection determination circuit 4 that the defect is detected, and when it is determined by the defect determination circuit 3 that the defect is the bright defect, the output circuit 5 outputs a second defect signal indicating that the bright defect is detected.

Further, the defect signal generating circuit 100 is provided with a defect release determination circuit 6 which compares a second operation value with the absolute value of a second reference value, and determines that the defect is no longer detected, when the absolute value of the second operation value is larger than the absolute value of the second reference value.

In the case where the sign of the first operation value is negative as described above, upon receipt of the defect flag set signal, the operation circuit 2 again operates the difference (A−B) between the level A of the input signal and the level B of the low pass filter signal, to calculates the second operation value. On the other hand, in the case where the sign of the first operation value is positive, upon receipt of the defect flag set signal, the operation circuit 2 operates (B−A) by making the sign of first operation value (A−B) opposite, to calculate the second operation value. Then, the operation circuit 2 outputs the above described second operation value to the defect release determination circuit 6.

The defect release determination circuit 6 compares the second operation value with the absolute value of the second reference value, and determines that the defect is no longer detected when the second operation value is larger than the absolute value of the second reference value. On the other hand, the defect release determination circuit 6 compares the second operation value with the absolute value of the second reference value, and determines that the defect is currently detected when the second operation value is smaller than the absolute value of the second reference value. The defect release determination circuit 6 outputs these release determination results to the output circuit 5.

Then, the output circuit 5 inhibits the output of the first and second defect signals on the basis of the output of the defect release determination circuit 6. That is, when the defect is determined to be no longer detected, the output circuit 5 inhibits the output of the first and seconds defect signals. On the other hand, when the defect is determined to be currently detected, the output circuit 5 continues to output the first and seconds defect signals.

Further, when determining that the defect is no longer detected, the defect release determination circuit 6 outputs a defect flag reset signal to the operation circuit 2. Thereby, when the level of the SBAD signal is changed corresponding to the next defect, the operation circuit 2 outputs the first operation value to the defect determination circuit 3 and the defect detection determination circuit 4.

Further, the defect signal generating circuit 100 is further provided with a timer circuit 7 which outputs an inhibition signal for inhibiting the defect detection of the dark defect or the bright defect for a predetermined period after the output of the defect signal from the output circuit 5 is inhibited.

A signal in which the output of the above described first and second defect signals of the output circuit 5 is inhibited, is inputted to the timer circuit 7. Upon receipt of the signal, the timer circuit 7 outputs the inhibition signal to the operation circuit 2. On the basis of the input of the inhibition signal, the operation circuit 2 outputs a signal by making the input signal equal to the low pass filter signal, that is, by making the operation value equal to zero. Thereby, it is determined by the defect detection determination circuit 4 that the defect is not detected. That is, the defect detection is inhibited during the predetermined period (the period during which the state where the operation value is equal to zero is maintained). As a result, the defect signal is not outputted from the output circuit 5 during the predetermined period.

It should be noted that here, the above described inhibition signal is inputted to the operation circuit 2, but the output circuit 5 may be arranged to be controlled by the inhibition signal so as to inhibit the output of the first and second defect signals during the predetermined period.

Further, the defect signal generating circuit 100 is provided with a bright defect detection inhibition circuit 8 for inhibiting the output of the second defect signal indicating that the bright defect is detected.

As described above, the bright defect, which is a defect in the state where the mirror face can be seen due to a production failure (the state without the dye film), may be smaller than the dark defect due to a stain and a flaw and have a defect period shorter than that of the dark defect. It is conceivable that when the detecting operation is arranged to be performed to output the second defect signal even in the case of such short defect period, the detecting operation may affect the servo performance.

Thus, in the case where the defect of the bright defect need not be detected in particular, the bright defect detection inhibition circuit 8 outputs a bright defect detection inhibition signal to the output circuit 5, to forcibly inhibit the output of the second defect signal. This enables the functions of the defect signal generating circuit 100 to be selectively switched in accordance with, for example, the specification of the servo system, and the like.

Next, an operation of the defect signal generating circuit 100 having the above described configuration and functions is explained in the following with reference to flow charts.

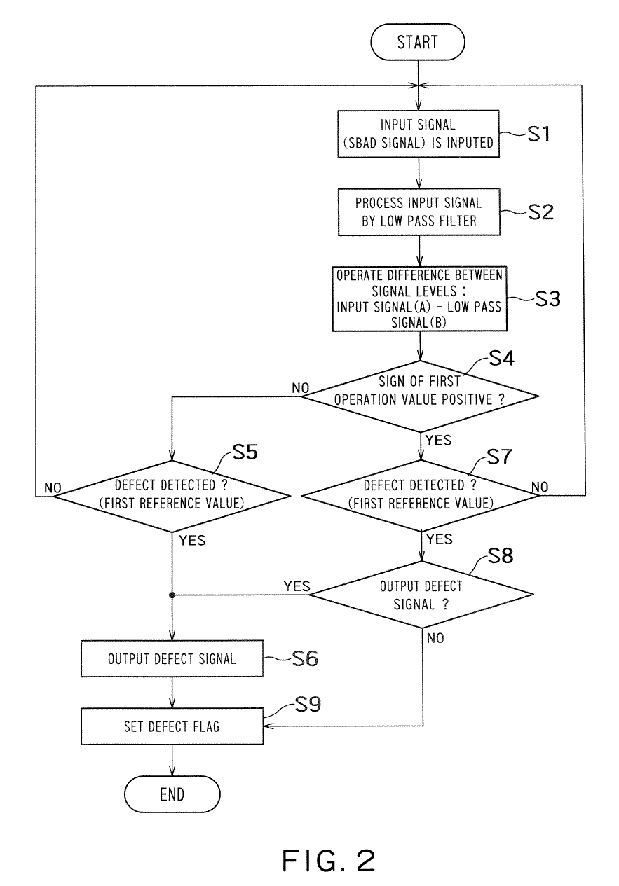

FIG. 2 is a flow chart showing an operation for outputting the defect signal, performed by the defect signal generating circuit according to a first embodiment of the present invention. First, as shown in FIG. 2, the input signal (SBAD signal) is inputted to the defect signal generating circuit 100 (step S1).

Next, the low pass filter circuit 1 processes the SBAD signal, and outputs the low pass filter signal having the time constant longer than the input signal to the operation circuit 2 (step S2).

Next, the operation circuit 2 operates the difference (A−B) between the SBAD signal and the low pass filter signal, and outputs the first operation value to the defect determination circuit 3 and the defect detection determination circuit 4 (step S3).

Next, the defect determination circuit 3 receives the output to determine whether the defect is the dark defect or the bright defect on the basis of the sign of the first operation value (step S4). In step 4, when the sign of the first operation value is positive, here, the defect is determined as the bright defect, while when the sign of the first operation value is negative, the defect is determined as the dark defect. The dark/bright determination result is outputted from the defect determination circuit 3 to the operation circuit 2 and the output circuit 5.

When the sign of the first operation value is determined to be negative, that is, the defect is determined as the dark defect, the defect detection determination circuit 4 compares the absolute value of the first operation value with the absolute value of the first reference value, so as to determine the presence or absence of the defect detection (step S5).

When the absolute value of the first operation value is not larger than the absolute value of the first reference value, it is determined by the defect detection determination circuit 4 that the defect is not detected, and the process again returns to step S1. On the other hand, when the absolute value of the first operation value is larger than the absolute value of the first reference value, it is determined by the defect detection determination circuit 4 that the defect is detected. These detection determination results are outputted to the output circuit 5 from the defect detection determination circuit 4.

When it is determined by the defect detection determination circuit 4 in step 5 that the defect is detected, the output circuit 5 outputs the first defect signal indicating that the dark defect is detected, as an output of the defect signal generating circuit 100 (step S6).

On the other hand, when the sign of the first operation value is positive, that is, the defect is determined as the bright defect, the defect detection determination circuit 4 compares the absolute value of the first operation value with the absolute value of the first reference value, so as to determine the presence or absence of the defect detection (step S7).

When the absolute value of the first operation value is not larger than the absolute value of the first reference value, it is determined by the defect detection determination circuit 4 that the defect is not detected, and the process returns to step S1. On the other hand, when the absolute value of the first operation value is larger than the absolute value of the first reference value, it is determined by the defect detection determination circuit 4 that the defect is detected. These detection determination results are outputted to the output circuit 5 from the defect detection determination circuit 4.

After step S7, the bright defect detection inhibit circuit 8 outputs a signal for inhibiting the output of the second defect signal to the output circuit 5, when the defect signal of the bright defect need not be outputted (step S8). On the other hand, when the defect signal of the bright defect needs to be outputted, the process moves to step S6, so that the second defect signal is outputted as an output of the defect signal generating circuit 100 from the output circuit 5.

After step S6, the defect detection determination circuit 4 outputs the defect flag set signal to the operation circuit 2 (step S9).

Through the above described flow, the operation of the defect signal generating circuit 100 for outputting the defect signal is completed, and next, the process moves to an operation for releasing the defect detection.

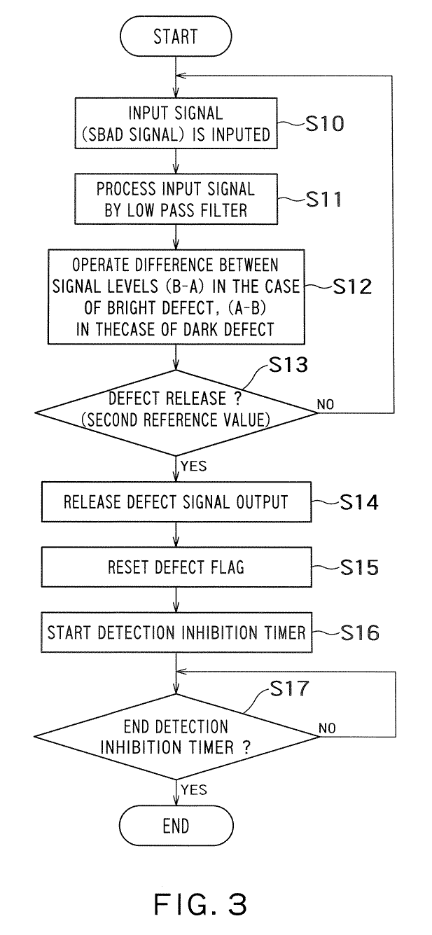

FIG. 3 is a flow chart showing an operation for releasing the defect detection, performed by the defect signal generating circuit according to the first embodiment of the present invention.

First, as shown in FIG. 3, the input signal (SBAD signal) is inputted to the defect signal generating circuit 100 (step S10).

Next, the low pass filter circuit 1 performs processing of the SBAD signal, and outputs the low pass filter signal having the time constant longer than the input signal to the operation circuit 2 (step S11).

Next, upon receipt of the defect flag set signal, the operation circuit 2 operates the difference between the SBAD signal and the low pass filter signal on the basis of the sign of the first operation value, and outputs the second operation value to the defect release determination circuit 6 (step S12).

When the sign of the first operation value is negative (when it is determined here that the dark defect is detected), the operation circuit 2 again operates the difference (A−B) between the level A of the input signal and the level B of the low pass filter signal to calculate the second operation value. On the other hand, when the sign of the first operation value is positive (when it is determined here that the bright defect is detected), the operation circuit 2 performs the operation (B−A) by making the sign of the difference operation (A−B) for calculating the first operation value opposite, so as to calculate the second operation value. Then, when receiving the defect flag set signal, the operation circuit 2 outputs the above described second operation value to the defect release determination circuit 6.

Next, the defect release determination circuit 6 compares the second operation value with the absolute value of the second reference value, to determine whether or not the defect is no longer detected (step S13).

The defect release determination circuit 6 compares the second operation value with the absolute value of the second reference value. Then, the defect release determination circuit 6 determines that the defect is no longer detected, when the second operation value is larger than the absolute value of the second reference value. On the other hand, when the second operation value is smaller than the absolute value of the second reference value, the defect release determination circuit 6 determines that the defect is currently detected, and the process returns to step S10. These release determination results are outputted from the defect release determination circuit 6 to the output circuit 5.

When it is determined in step 13 that the defect is not detected, the output circuit 5 inhibits the output of the first and second defect signals (step S14).

Next, the defect release determination circuit 6 outputs the defect flag reset signal to the operation circuit 2 (step S15).

Next, upon receipt of the signal for inhibiting the output of the first and second defect signals from the output circuit 5, the timer circuit 7 starts timer measurement for a predetermined period during which the output circuit 5 inhibits the output of the defect signal (step S16). During the predetermined period, that is, the period until the counting by the detection inhibition timer is completed, the output circuit 5 outputs the inhibition signal to the operation circuit 2 to inhibit the detection of the defect (step S17) Through the above described flow, the operation for releasing the defect detection by the defect signal generating circuit 100 is completed, and the process again moves to the operation for outputting a next defect signal.

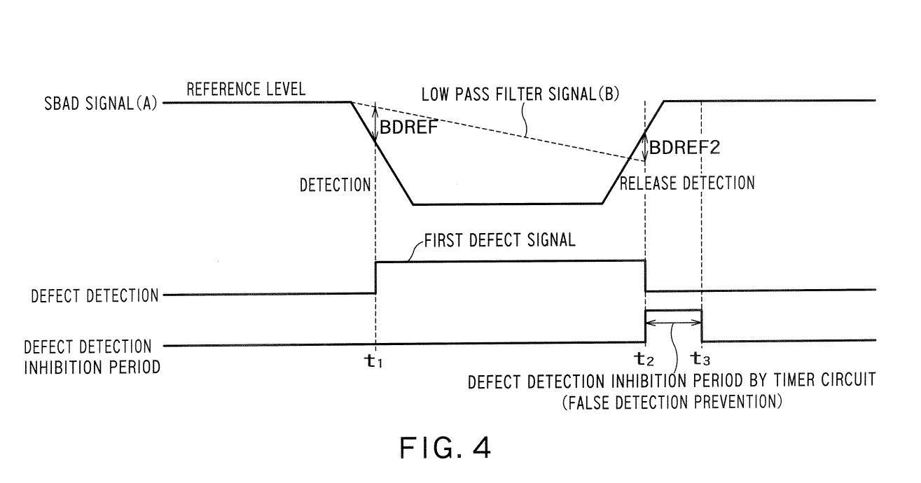

Timing waveforms of respective signals which are processed in the above described flows are explained. FIG. 4 is a figure showing timing waveforms when the defect detection of the dark defect is performed by the defect signal generating circuit according to the first embodiment of the present invention.

As shown in FIG. 4, the SBAD signal is lowered to a level below the reference level corresponding to the dark defect. Then, after time t1, the absolute value of the first operation value (A−B) becomes larger than the absolute value of the first reference value (BDREF), and thereby the defect detection determination circuit 4 determines that the defect is currently detected. Further, since the first operation value (A−B) is negative, the defect determination circuit 3 determines that the defect is the dark defect. On the basis of these determination results, the output circuit 5 outputs the first defect signal.

Next, when the level of the SBAD signal is raised corresponding to the disappearance of the dark defect, the second operation value (A−B) becomes larger than the second reference value (BDREF2) at time t2, and thereby the defect release determination circuit 6 determines that the defect is no longer detected. On the basis of the determination, the output circuit 5 inhibits the output of the first defect signal.

Then, the SBAD signal and the low pass filter signal are operated as having an equal level by the operation circuit 2 during the predetermined period from time t2 to time t3, specified by the period timer circuit 7. Thereby, it is determined by the defect detection determination circuit 4 that the defect is not detected. That is, the defect detection is inhibited during the predetermined period, as a result of which the output of the first defect signal from the output circuit 5 is restricted.

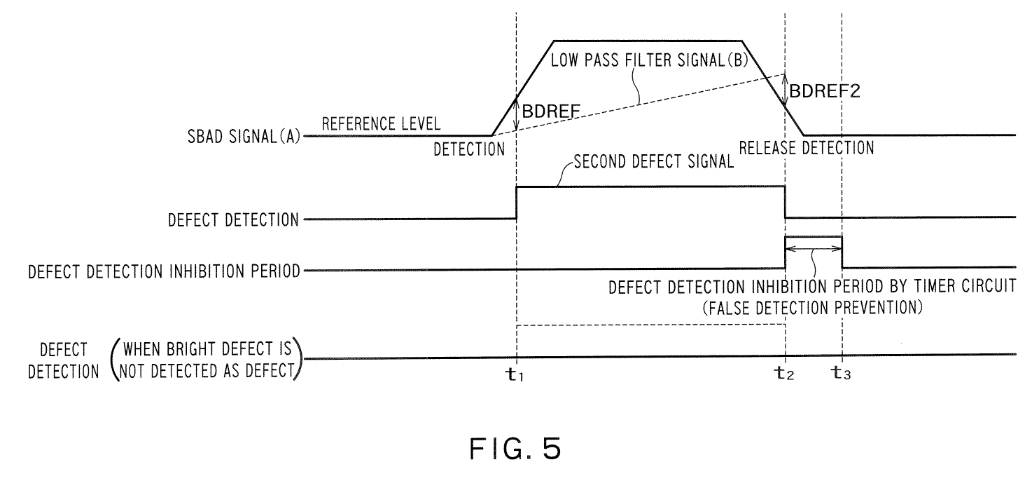

FIG. 5 is a figure showing timing waveforms when the defect detection of the bright defect is performed by the defect signal generating circuit according to the first embodiment of the present invention.

As shown in FIG. 5, the signal level is raised to a level above the reference level corresponding to the bright defect. Then, after time t1, the absolute value of the first operation value (A−B) becomes larger than the absolute value of the first reference value (BDREF), and thereby the defect detection determination circuit 4 determines that the defect is currently detected. Further, since the first operation value (A−B) is positive, the defect determination circuit 3 determines that the defect is the bright defect. On the basis of these determination results, the output circuit 5 outputs the second defect signal.

Next, when the level of the SBAD signal is lowered corresponding to the disappearance of the bright defect, the second operation value (B−A) becomes larger than the second reference value (BDREF2) at time t2, and thereby the defect release determination circuit 6 determines that the defect is no longer detected. On the basis of the determination, the output circuit 5 inhibits the output of the second defect signal.

Thus, similarly to the case in FIG. 4, the SBAD signal and the low pass filter signal are operated as having an equal level by the operation circuit 2 during the predetermined period from time t2 to time t3, specified by the period timer circuit 7. As a result, the output of the first defect signal from the output circuit 5 is restricted during the predetermined period.

When the defect signal of the bright defect need not be outputted, the bright defect detection inhibition circuit 8 controls the output circuit 5, so that the second defect signal is not outputted during the period from time to to time t2.

An example of an optical disc device 200 provided with the defect signal generating circuit 100 having the above described configuration and functions, is explained.

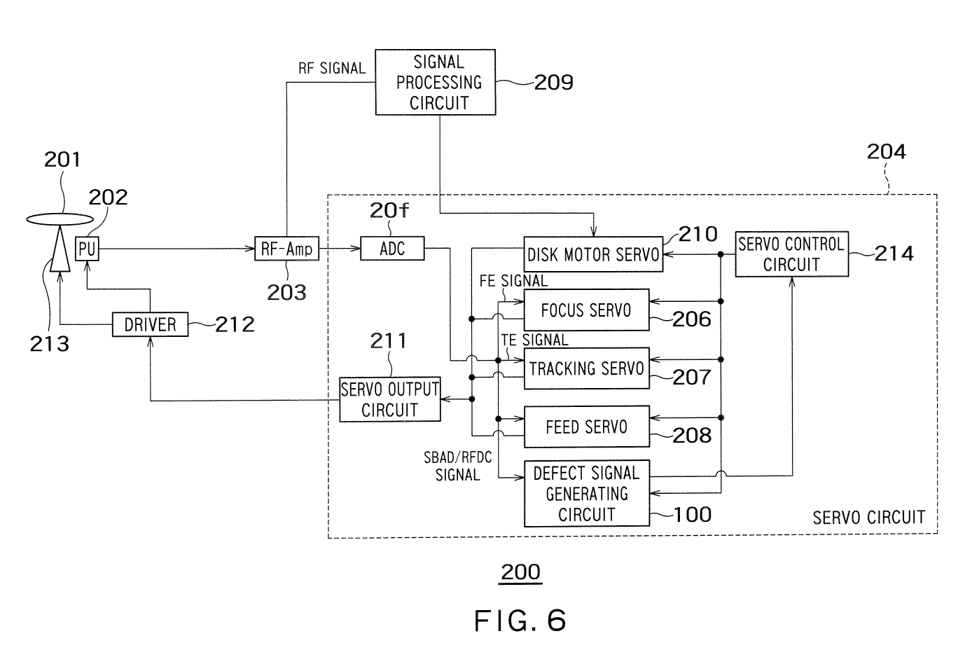

FIG. 6 is a block diagram showing an example of a main part configuration of an optical disc device provided with the defect signal generating circuit according to the first embodiment of the present invention.

As shown in FIG. 6, a signal read from a disk 201 is inputted to an RF-Amp 203 from a PU (pickup) 202. The RF-Amp 203 generates signals (a focus error (FE) signal, a tracking error (TE) signal, an RF ripple signal, a sub-beam addition signal, an RF signal, an RFDC signal) required for disk reproduction.

An ADC (analog to digital converter) 205 of a servo circuit 204 converts the signals generated by the RF-Amp 203 to digital data, and outputs the data to a focus servo 206, a tracking servo 207, and a feed servo 208.

A signal processing circuit 209 performs processing of the RF signal, and outputs the processed signal to a disk motor servo 210 of the servo circuit 204.

The servo output circuit 211 controls a motor 213 and the PU 202 by a driver 212, to perform the reproduction of the disk 201, on the basis of outputs of the focus servo 206, the tracking servo 207, the feed servo 208, and the disk motor servo 210.

When there is a defect in the disk 201, the SBAD signal (or RFDC signal) is inputted to the defect signal generating circuit 100, so that the defect detection is performed. Thus, a servo control circuit 214 is arranged to output a control signal to control the output of the focus servo and the tracking servo on the basis of the output signal of the defect signal generating circuit 100, thereby enabling the reproduction of the disk 201 to be performed without malfunction.

As described above, on the basis of the defect signal generating circuit according to the present embodiment, it is possible to more accurately detect the dark defect and the bright defect of the optical disk as a defect, and to output the defect signal to the servo system of the optical disk reproducing device.

It should be noted that in the above described embodiment, the first reference value for determining the detection of the defect and the second reference value for determining the completion of the defect detection are suitably set on the basis of the kind, and standard of the optical disk, and the specification of the servo system, or the like.

What is claimed is:

1. A defect signal generating circuit comprising:
a low pass filter circuit which receives an input signal whose signal level is changed from a reference level to a higher level or a lower level corresponding to a dark defect or a bright defect of a optical disk, and outputs a low pass filter signal having a time constant longer than the input signal;
an operation circuit which operates a difference between a level of the input signal and a level of the low pass filter signal, and outputs a first operation value;
a defect determination circuit which determines whether a defect is the dark defect or the bright defect on the basis of the sign of the first operation value;
a defect detection determination circuit which compares the absolute value of the first operation value with the absolute value of a first reference value, and determines that a defect is detected when the absolute value of the first operation value is larger than the absolute value of the first reference value; and
an output circuit which outputs a first defect signal indicating that the dark defect is detected, when it is determined by the defect detection determination circuit that the defect is detected, and when it is determined by the defect determination circuit that the defect is the dark defect, and which outputs a second defect signal indicating that the bright defect is detected, when it is determined by the defect detection determination circuit that the defect is detected, and when it is determined by the defect determination circuit that the defect is the bright defect.

2. The defect signal generating circuit according to claim 1,
wherein the operation circuit performs operation similarly to the difference operation to output a second operation value, when the sign of the first operation value is negative, while the operation circuit performs operation by making the sign of the difference operation opposite, to output the second operation value, when the sign of the first operation value is positive,
further comprising a defect release determination circuit which compares the second operation value with the absolute value of a second reference value, and determines that the defect is no longer detected when the second operation value is larger than the absolute value of the second reference value, and
wherein the output circuit inhibits the output of the first and second defect signals on the basis of an output signal of the defect release determination circuit.

3. The defect signal generating circuit according to claim 2, further comprising a timer circuit for inhibiting the detection of the defect of the dark defect or the bright defect during a predetermined period after the output of the defect signal from the output circuit is inhibited.

4. The defect signal generating circuit according to claim 1, further comprising a bright defect detection inhibition circuit for inhibiting the output circuit from outputting the second defect signal.

5. The defect signal generating circuit according to claim 2, further comprising a bright defect detection inhibition circuit for inhibiting the output circuit from outputting the second defect signal.

6. The defect signal generating circuit according to claim 3, further comprising a bright defect detection inhibition circuit for inhibiting the output circuit from outputting the second defect signal.

7. The defect signal generating circuit according to claim 1, wherein the input signal is an RFDC signal or a SBAD signal.

8. The defect signal generating circuit according to claim 2, wherein the input signal is an RFDC signal or a SBAD signal.

9. The defect signal generating circuit according to claim 3, wherein the input signal is an RFDC signal or a SBAD signal.

10. The defect signal generating circuit according to claim 4, wherein the input signal is an RFDC signal or a SBAD signal.

11. A servo circuit comprising:
a defect signal generating circuit which SBAD signal or RFDC signal is inputted to;
a focus servo which a focus error (FE) signal is inputted to;
a tracking servo which a tracking error (TE) signal is inputted to;
a feed servo;
a disk motor servo;
a servo control circuit which is arranged to output a control signal to control the output of the focus servo and the tracking servo on the basis of the output signal of the defect signal generating circuit; and
a servo output circuit which controls a motor and a PU by a driver, to perform the reproduction of the disk, on the basis of outputs of the focus servo, the tracking servo, the feed servo, and the disk motor servo;
wherein the defect signal generating circuit comprises a low pass filter circuit which receives SBAD signal or RFDC signal, and outputs a low pass filter signal having a time constant longer than SBAD signal or RFDC signal; an operation circuit which operates a difference between a level of the input signal and a level of the low pass filter signal, and outputs a first operation value; a defect determination circuit which determines whether a defect is the dark defect or the bright defect on the basis of the sign of the first operation value; a defect detection determination circuit which compares the absolute value of the first operation value with the absolute value of a first reference value, and determines that a defect is detected when the absolute value of the first operation value is larger than the absolute value of the first reference value; and an output circuit which outputs a first defect signal indicating that the dark defect is detected, when it is determined by the defect detection determination circuit that the defect is detected, and when it is determined by the defect determination circuit that the defect is the dark defect, and which outputs a second defect signal indicating that the bright defect is detected, when it is determined by the defect detection determination circuit that the defect is detected, and when it is determined by the defect determination circuit that the defect is the bright defect.
